(19) United States
(12) Patent Application Publication
(10) Pub. No.: US 2002/0087892 A1
(43) Pub. Date: Jul. 4, 2002

(54) Authentication method and device

(76) Inventor: Hideyo Imazu, Miyamae-ku (JP)

Correspondence Address: Clifford Chance Rogers & Wells LLP, 200 Park Avenue, New York, NY, 10166-0153, US

(21) Appl. No.: 09/997,092

(22) Filed: Nov. 29, 2001

(30) Foreign Application Priority Data
Dec. 28, 2000 (JP) 2000-402152

(51) Int. Cl. H04L 9/32

(52) U.S. Cl. 713/202

(57) ABSTRACT

[PROBLEM] Person authentication and authentication device of the present invention aims at providing a user with services of easy, inexpensive, highly secure, and reliable person authentication.

[MEANS TO SOLVE THE PROBLEMS]

Authentication method adopted by the present invention comprises: a step that forwards to a communication device of a user a registration identifier that identifies the user and/or the communication device by including the identifier in an address of registration screen peculiar to the user and/or the communication device; and a step that, when the address is accessed, and a first password is entered and replied to the registration screen, authenticates the user based on the registration identifier and the first password; and a step that sends a login screen display to the user when the authentication step is successful, which the step is comprised of a step where the login screen display comprises a field for entering a second password, and a login identifier to identify the user and/or the communication device; and a step that authenticates the user based on the login identifier contained in the login screen display replied by the user, and the second password.

### BACKGROUND OF THE INVENTION

1. Technical Field of the Invention

The present invention generally relates to the transmission of digital information and more particularly to the arrangement and/or handling of digital information for confidential or secured communication including the mechanism for verifying the identity or qualification of a system user. The present invention is well suited to an authentication method or device when a user (client) of such a small potable terminal as a cellular phone, a car phone, PHS (Personal Handy-phone System), PDA (Personal Digital Assistant), etc. uses a network like Internet to access a server which stores desired information.

2. Prior Art

Owing to IT technology innovation, the global world based on Internet has been evolved, and its convenience has been spotlighted by the public attention. The information society where information digitalization and Internet are combined has come to greatly impact human activities ranging from company activities down to private life. Users can simultaneously access various servers connected to Internet to obtain versatile data and services. And recently, it is not only desktop personal computers (PCs), but also small portable terminals such as cellular phones, PDA, etc. that can have an access to Internet.

As a result of Internet linking individuals and companies, it becomes increasingly necessary to safely distribute information (e.g., commercial information or musical information provided only with specific members, or customer information which companies don't want to be leaked to any irrelevant third party) or electronic commercial transactions (e.g., online shopping which requires transmission of credit card information). The site that wants to limit users who have access to information typically employs a system that registers users online or offline, and then admits access to information only by those registered users.

For safe communication, cryptograph is employed. Cryptograph consists of a secrets keeping mechanism and authentication. A secrets keeping mechanism consists of encryption that encodes plaintext into cipher text, and decryption that decodes encrypted cipher text into plaintext, and it is an algorithm (a cipher system) and a key that dictate encryption and decryption. Typically, a small information device cannot encrypt/decrypt electronic mail, but WWW (hereinafter, simply called “web”) has a secret communication environment that can perform encryption/decryption. Authentication can be roughly classified as person identification, message authentication, and digital signature depending on subject to be identified. Person identification is also called party authentication or user authentication, and thus, it is a technique to be used for a multi-user computer system or for a network system to verify that the party you are communicating with is real, where the simplest way is to use a password. Typically, person identification is done by using a combination of a user ID (or a user name) that a user presets and stores into (a storage for an access authority list in) a server in advance, and a password, in which case a user is required to enter his or her user ID and password when logging in a computer system or a network. When the user enters both data, it is authenticated by cross-checking the two to make sure whether it is the same as the one registered in (the storage for the access authority list in) the server, and only at the time of being authenticated, use of the system is allowed within the limits of the registration made in the access authority list. Here, the user ID is a user identification name in the system, and the password is a character string consisting of numbers and alphabetical letters that the user has arbitrarily chosen.

Problems to Be Solved by the Invention

However, since a user using a small portable terminal usually makes a key entry with one finger, the conventional authentication method that requires many key entry operations for a user ID and a password. Internet URL, etc. becomes a burden to the user in terms of entering and managing them. On the other hand, there is a need to maintain security to be able to attain an authentication method that uses a user ID and a password for realization of secure communication. Also, unlike a PC, cipher codes available on a small portable terminal are limited in many cases. For example, a cellular phone cannot use a cipher for electronic mail enabled communication, but can use a cipher for WWW (hereinafter, simply called “web”) enabled communication.

Sending to a small portable terminal a URL for e-mail login containing a user identification part can provide facilities for a user, but when electronic mail cannot be enciphered, there will arise a danger that the URL for the user may be furtively looked at.

On the contrary, in addition to, or in place of, a user ID and a password. biometrix (bio-authentication) that uses bodily features (such physical features as a finger print, a palm pattern, a vocal pattern, a retinal pattern, etc., handwriting, and key-entry habits) is proposed as a new candidate. Use of biometrix increases security, but a purchase of a device dedicated for reading bodily information (a finger print reader, for example) will become a burden to a user. In addition, it is only such bio-information as is supported by an authentication device that can be used.

Thus, a generalized object of the present invention is to propose a novel and useful authentication method and device that will help solve the conventional problems.

More specifically, an exemplified object of the present invention is to propose an authentication method and device that can authenticate a user easily, comparatively cheaply, and safely.

Further, another exemplified object of the present invention is to offer an authentication method and device that can help lighten a user's burden by alleviating key entry operations of a user who uses a small portable terminal.

### BRIEF SUMMARY OF THE INVENTION

In order to achieve the above objects, an authentication method as one aspect of the present invention comprises the steps of: sending an address of a registration screen to a communication device of a user, the address including a registration identifier for identifying the user and/or the communication device; authenticating the user based on the registration identifier and a first password that is entered in the registration screen and returned when the address is accessed; sending a login screen to the user when the authenticating step succeeds, the login screen including a field into which a second password is entered, and a login identifier for identifying the user and/or the communication device; and authenticating the user based on the login identifier included in the login screen, and the second password that are returned by the user. According to the authentication method, which follows the steps using the registration screen and the first password, the user may circumvent the load of keying the identifier in the login screen and handling the identifier, and thus the user using a small portable terminal particularly benefits from the authentication method. Moreover, the authentication method may ensure the same level of security as the authenticating method using the identifier and the (second) password. Even if he address of the registration screen were sent without using encryption, and resultantly leaked, the first password would secure legitimateness of the user.

The registration identifier and the login identifier preferably differ from each other. The login identifier that could not be presumed from the registration identifier would prevent the address of the registration screen from providing a clue to an unauthorized login. The first and second passwords may either be the same or different. The same passwords could reduce the load of the user in handling the password.

The identifier in the login screen may be a device identifier that the communication device automatically sends for particularly identifying the communication device. Some of cellular phones, etc. send a notification of the device identifier (specific identifier for each cellular phone) to the server as part of communication services irrespective of the user's operations. The device identifier is assigned individually even among the same models, and thus identifies both the model and the user who uses the model. Therefore, utilizing this identifier would allow the user to omit setting the identifier of the communication device independently from the login screen.

The above step of sending the login screen to the user enables the user to save contents of the login screen in the communication device. This is made possible when the communication device is capable of saving the login screen. Alternatively, the above step of sending the login screen to the user may enable the user to save an address of the login screen in the login screen, where the address of the login screen includes the identifier. In this instance, the communication device, for example, may bookmark a URL of the login screen including the identifier.

The authenticating step using the registration identifier and the first password may disable the registration screen to be accessed when the authenticating step succeeds. This would prevent someone who might attempt to cast a furtive glance at the address of the registration screen from succeeding in registration on the premise that the authorized user has completed the registration, thereby enhancing the security. On the other hand, even if the one who has cast a furtive glance had completed the registration, the authorized user would become aware of abnormal conditions from inaccessibility to the registration screen, and could take prompt measures such as retrying the registration.

The first password that has been entered in the registration screen and returned may be accepted only when the password is returned within a predetermined time. This would allow the user authentication using the first password to be implemented when the password is entered in the registration screen and returned within a predetermined time. Even if other than the authorized user could acquire the registration screen, time period would expire while seeking the first password, so as to enhance the security.

An authentication device as another aspect of the present invention comprises: a storage part that stores user information, a registration identifier a registration password verification information, login identifier, login password verification information while correlating them with one another; a first control part that sends an address of a registration screen to a communication device of a user, the address including a registration identifier for identifying the user and/or the communication device; a second control part that provides the communication device with the registration screen including a field into which a registration password is entered, and the registration identifier in response to a request for the registration screen from the communication device, and that authenticates the user with reference to the storage part when the user enters the login password in the registration screen and returns the same; and a third control part that provides the communication device with the login screen including a field into which a login password is entered, and the login identifier when the authentication succeeds, and that authenticates the user with reference to the storage part when the user enters the login password in the login screen and returns the same. This authentication device controls the registration through the second control part, and the login through the third control part. The first, second, and third control parts may be the same component, or any two of the control parts may be the same. Since the login screen provided after the registration control includes the login identifier, the user may circumvent the load of keying the same in the login screen and handling the identifier, and thus the user using a small portable terminal particularly benefits from the authentication device. Even if the registration screen were sent or received without using encryption, the registration password would secure that the other party is an authorized user. The registration password and the login password may be either the same or different. Nonetheless, the registration identifier and the login identifier preferably differ from each other. The login identifier that could not be presumed from the registration identifier would prevent the address of the registration screen from providing a clue to an unauthorized login.

Other objects and further features of the present invention will become readily apparent from the following description of the embodiments with reference to accompanying drawings.

### BRIEF DESCRIPTION OF THE DRAWINGS

FIG. 1 is a system organization chart of the authentication system of the present invention.

FIG. 2 is a rough schematic of a registration screen to be used for the authenticator in the authentication system shown in FIG. 1.

FIG. 3 is a schematic of a login screen that the authenticator uses in the authentication system shown in FIG. 1.

FIG. 4 is a flowchart to explain the steps in the authentication system shown in FIG. 1.

FIG. 5 is a variation example of the flowchart shown in FIG. 4.

### DESCRIPTION OF CODES

1 Authentication System

10A User (and/or his or her cellular phone)

10B Illegitimate user (and/or his or her cellular phone)

20 Information provider

30 Internet

100 Authenticator

110 Control

120 Communication port

130 Random number generator

140 Encryptor/decryptor

150 Memory

200 Storage

210 User management table

220 Registration screen saving table

230 Login screen management table

### DETAILED DESCRIPTION OF THE INVENTION

Preferred Embodiments of the Invention

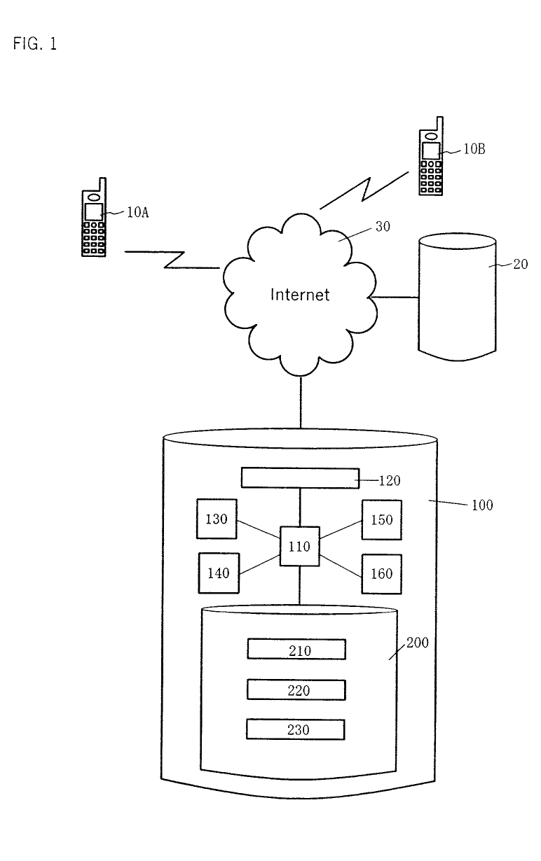

Below, authentication system 1 of the present invention will be explained by referring to attached figures. FIG. 1 is a conceptual organization chart of authentication system 1 of the present invention. As shown in FIG. 1, authentication system 1 comprises a plurality of users (clients) 10 connected to Internet 30 (here, reference number 10 is to represent 10A, 10B, etc.), information provider 20, and authenticator 100.

User 10 can be an individual or a company, and its installation place can be domestic or abroad, but typically, it refers to a platform operated by an individual or enterprise user or software stored on that platform, or it even refers to a user himself in this embodiment of the invention. As a machine that sends and receives, processes and stores information, the platform widely comprises not only a PC but also a digital TV, PDA, a car phone, a cellular phone, PHS, WAP (Wireless Application), a game machine, etc. However, user 10 in this embodiment of the present invention uses a cellular phone comprising a screen scribbling function and software stored in it. The screen scribbling function is a function that serves to capture and save an image, and is widely used in such cellular phones as the i-mode cellular phone manufactured by DoCoMo Co.

User 10 stores a browser needed for communication with information provider 20 and authenticator 100 via Internet 30. The browser enables user 10 to use e-mail. Thus, client 10 can communicate with information provider 20 and authenticator 100 via wireless communication or can communicate with them over Internet. Such a browser as this can desirably bookmark the URL for information provider 20 and authenticator 100.

Information provider 20 stores information and/or services that user 10 desires. In order to admit information access only to a specific user for commercial reasons and/or from information security, information provider 20 generally needs user authentication when a user logs in. For example, the case is where a member alone is allowed to have access to specific information such as a stock forecast, a meeting, a horse-race forecast, etc., or where only an operator is allowed to access confidential information about his company. Information provider 20 can be organized with the function of authenticator 100 included in it, as discussed later, as a one piece or can be connected to it without using Internet 30. Information provider 20 generally comprises the hardware component of authenticator 100, and so, a detailed description of it will be omitted here.

Internet 30 is a typical example of a network, but the present invention does not prohibit itself from being applied for LAN (Local Area Network), MAN (Metropolitan Area Network), WAN (Wide Area Network), commercial exclusive lines (such as America Online), and other online networks.

Authenticator 100 comprises CPU 110, communication port 120, random number generator 130, memory 140, encryptor/decryptor 150, and storage (data storage) 200. In addition, authenticator 100 can also function as a mail server and a news server. CPU 110 comprises a wide selection of processing units such as MPU or whatever, thus controlling each part of authenticator 100. Authenticator 100 can comprise dedicated processing units which are controlled by CPU 110 and process various types of databases on data storage 200. Also, authenticator 100 comprises an input means not included in the illustration (such as a keyboard, a mouse or other pointing devices), a display, etc. Via an input means, the operator of authenticator 100 can enter various kinds of data into storage 200, and set up necessary software in memory 150 and storage 200.

If necessary, authenticator 100 can be connected to other computers through LAN and other network and CPU 110 can communicate with such computers. In connection with the present invention, CPU 110 can build various types of databases (user managed table 210, registration screen management table 220 and login screen management table 230) stored in storage 200, and authenticate user 10 by use of a relevant database.

Communication port 120 includes USB port, IEEE 1394 port, etc., which can be connected, via a modem and a terminal adapter (TA), to various dedicated lines that, in turn, are connected to a public telephone line network and ISDN connectable to Internet (if necessary, through ISP—Internet Service Provider). Further, when authenticator 100 is linked to LAN, communication port 120 also can include a hub and a router.

Random number generator 130 comprises a program language having a function that generates random numbers. According to the present invention, ID is not determined by user 10, but CPU 110 allocates a random ID to user 10 based on a random number generated by random number generator 130.

When storing into storage 200 a password set up by user 10, and sending and receiving data over a network, encryptor/decryptor 140 converts (encrypt) data so that a third party may not understand it, and converts (decrypts) the encrypted password of user 10, extracted from storage 200, to be decipherable when authenticator 100 authenticates user 10. It is a procedure (an algorithm), and a key which is a parameter consisting of alphanumericals and symbols randomly lined up (a character string) that dictate encryption and decryption. The procedure is a fixed part of hardware and software, and the key is a convertible character string. The mechanism for a procedure (an encryption system) differs between an encryption key and a decryption key even in the secret key encryption where a sender and a receiver share the same key in confidence, and the encryption key can be made open, and the decryption key can be an open key encryption that is kept secret on the side of a receiver. Further, any encryption techniques known in the industry can be applied to the present invention, and so, detailed description of encryption will be omitted here.

Memory 150 contains RAM and ROM, thereby saving temporarily data read out from, and written to, storage 200. Memory 150 stores various kinds of software. firmware, and other software necessary for the operation of CPU 110.

Mailer 160 is software for sending e-mail to, and receiving e-mail from, user 10, and comprises a storage part, not illustrated in the figure, for a receiving tray to store mail received from user 10 and others, a sending tray to store mail bound for user 10 and others, an already sent tray to store mail already sent to others, an already deleted tray to store mail deleted from arbitrary trays, and a drafting tray to store mail on a drafting stage. In this embodiment of the present invention, the mail server for authenticator 100 is provided separately from the authentication device, but as stated above, authenticator 100 can act as a mail server. Mailer 160 sends to user 10 a message like a stereotyped phrase (e.g., “Thank you for accessing our URL. Please access the registration screen below (or the activation screen) within 3 hours.”), a registration screen URL peculiar to user terminal 10 (i.e., a URL including a registration identifier explained later) and other information. Here, the reason for writing ‘a registration screen peculiar to a user terminal’ is because since depending on its type, a cellular phone has a different format for a site from where information can be received, it is necessary to use one that fits to the user's cellular phone type as explained later. However, the present invention does not essentially require that authenticator 100 comprise mailer 160.

Although storage 200 comprises databases for user management table 210, registration screen management 220 and login screen management table 230, it is not limited to this.

User management table 210 contains, by way of illustration, user 10's name, address, sex, age, birthday, telephone number, e-mail address, machine type of the cellular phone used, authentication information for one or more passwords (it can be the password itself but it should include all information necessary to authenticate them), type of a process corresponding to type of a cellular phone, bank account number, credit card number, key for encryption, and other ID information. Here. ‘type of a process corresponding to type of a cellular phone’ is not necessarily needed all the time, but when the format of the Web screen displayable depending on the type of a cellular phone changes or its preservation function changes (e.g., the content of a certain Web screen cannot be preserved, but its bookmark can be preserved), a process that fits for a pertinent cellular phone is performed (e.g., the Web screen is changed so that it fits for the cellular phone, and then, necessary ID is inserted in its URL). Registration of user 10 is performed offline in advance by authenticator 100 and its administrator using a relevant cellular phone, mail or fax, etc., and then later, upon online connection request from user 10, authenticator 100 will re-register user 10. Online registration operation is done by user 10 who completes and sends a specific form provided by CPU 110. By using his or her own terminal, user 10 can confirm his or her ID information at any time, and can change it if necessary.

By referencing user management table 210, CPU 110 authenticates user 10 when user 10 wants to access authenticator 100. In addition, when user 10 updates or deletes registered information, further additional authentication can be performed. Authenticator 100 can, if necessary, be provided with a voice authenticator that authenticates user 10 by his voiceprint, in which case the ID information should contain the voiceprint of user 10.

Registration screen management table 220 houses registration screen 221 which is a registration screen peculiar to a user and/or a communication device that the user uses (i.e., a cellular phone in this embodiment). As explained later, registration screen 221 is provided by CPU 110, via e-mail, to the e-mail address of the cellular phone of user 10 registered in advance. It is preferable that such provision of registration screen 221 be limited in terms of time. By so doing, even if non-legitimate users (false users) obtain the URL of registration screen 221, time-out state is brought in, as explained later, while they fumble for the password, thus improving security.

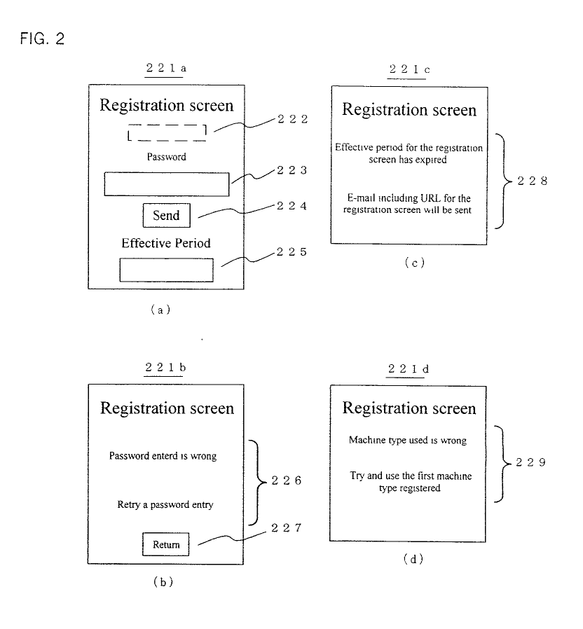

Registration screen 221 (reference number ‘221’ represents 221a, 221b, etc.) comprises a number of types and fields as shown in FIGS. 2(a) through (d). Here FIG. 2 is a rough block chart for registration screen 221 to be presented to user 10 from authenticator 100 via Web enabled communication. In the same chart, FIG. 2(a) shows the first registration screen 221a to be presented to user 10. FIG. 2(b) shows registration screen 221c that is given when valid user 10 enters or replies an invalid registration password in registration screen 221a. FIG. 2(c) shows registration screen 221d that is given when valid user 10 enters or replies a registration password in registration screen 221a after the password has expired. FIG. 2(d) shows registration screen 221d that is given when a person who does not use the same type of machine as the user and/or communication device registered on user management table 210 enters or replies the registration password in registration screen 221a.

First in reference to FIG. 2(a), registration screen 221a comprises fields for registration identifier 222, registration password 223, send button 224 and effective period 225. However, registration screen management table 220 houses registration screen 221a where registration identifier 222 and effective period 225 are planned to be entered (i.e., before they are entered). Field 222 is an ID that identifies the user and/or the communication device registered in user management table 210. Registration identifier 222 is imbedded in registration screen 221a in a way invisible or hidden from a person who receives registration screen 221a or in such a way that it can be confirmed by the person who receives registration screen 221a. In this embodiment, as stated above, registration identifier 222 uses, on as is basis, what is sent to user 10 by mailer 160, but it can use other identifier. Since registration identifier 222 is already imbedded in registration screen 221a, user 10 is relieved from the burden of entering or managing this. Field 223 is a field for entering the registration password (e.g., of eight digit characters) that the user has previously chosen and registered in user management table 210. Field 224 is a field to be clicked when the user has entered the registration password, which is then returned to authenticator 100 through Web enabled communication. Field 225 is built in such a way as can be confirmed by user 10 or in a hidden invisible way, i.e., it is a field that indicates an effective period of time (e.g., three hours) between when user 10 receives a message from mailer 160 and when he must complete the registration password. For the starting and ending time for effective period 225, any arbitrary time can be set.

In reference to FIG. 2(b0, registration screen 221b comprises fields for message 226 and for ‘Return’ button 227. Message 226 is displayed to indicate that the registration password entered is wrong and that a password retry is prompted. ‘Return’ button 227 is a button that makes it possible for user 10 to retry the password by switching registration screen 221b to 221a.

In reference to FIG. 2(c), registration screen 221c comprises a field for message 228. Message 228 informs user 10 that the effective period entered has already expired. In this embodiment, registration screen 221c is so organized that it is given in preference to registration screen 221b if the effective period is over, regardless of whether registration password 223 entered into registration screen 221a is right or wrong.

In reference to FIG. 2(d), registration screen 221d comprises a field for message 229. Message 229 informs user 10 that the type of cellular phone used is different from that previously registered in user storage database 210. Registration screen 221d is given when a user's cellular phone 10 automatically posts the device identifier (i.e., the proper identifier of the cellular phone) to authenticator 100. Now, to take an example, let's consider a case where user 10B gets possession of URL plus registration password for registration screen 221a that is sent to user 10A, thus obtaining registration screen 221a and then entering the registration password in response. If the cellular phone of user 10B is of a type that sends its device identifier to authenticator 100 automatically, control part 110 can verify that the device identifier of user 10B is different from that of user 10A based on other authentication information stored in registration identifier 222 and user management table 210. As a result, subsequent login screen display 231a can be prevented from being sent.

Login screen management table 230 houses login screen display 231 (reference number ‘231’ is to represent 231a, 231b, etc.) into which a login identifier identifying a user and/or communication device (i.e., a cellular phone in this embodiment) is planned to be imbedded (i.e., before the imbedding takes place) in a way hidden from user 10. Login screen 231 to be provided to user 10 has an identifier imbedded; therefore, user 10 need not enter this from the cellular phone, thus contributing to the alleviation of key operation. Even if an imprudent person peeks at the login screen display 231 on the cellular phone, he cannot recognize the identifier, thus improving security.

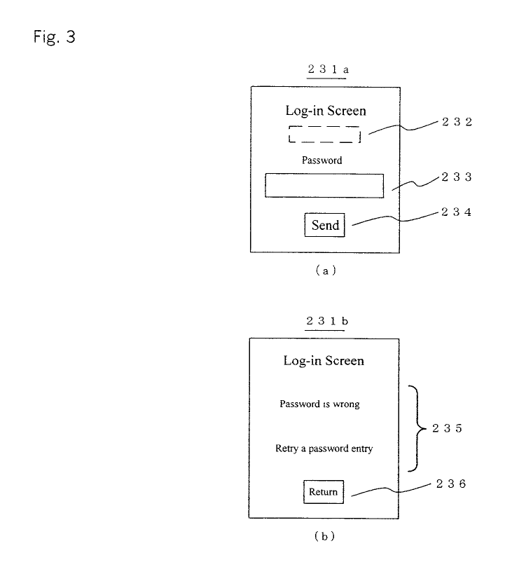

Login screen display 231 comprises, as shown in FIGS. 3(a) and (b), a number of types and fields. Here, FIG. 3 is a rough block figure of login screen display 221 to be given to user 10 from authenticator 100 via Web enabled communication. In the same figure. FIG. 3(a) shows login screen display 231a that is given when legitimate user 10 enters or replies a correct password to registration screen 221a before the effective period expires, and as a result, it is authenticated by control part 110. FIG. 3(b) shows login screen display 231a that is given when legitimate user 10 enters or replies a wrong login password to registration screen 231a.

First in reference to FIG. 3(a), login screen display 231a comprises fields for login identifier 232, password 233, and send button 237. However, login screen display 231a in which login identifier 232 is planned to be inputted (i.e., before it is inputted) is stored in login screen display storage table 220. The content of login screen display 231a in which login identifier has been entered is saved in user cellular phone 10, or part or all of login identifier 232 or URL of login screen display 231a containing information related to this is saved (book-marked) by user cellular phone 10.

Field 232 indicates an identifier that identifies a user and/or his communication device registered in user management table 210. A login identifier is imbedded in registration screen 221a so as to be confirmed by a user or, more preferably, in a way hidden, invisible from user 10 who receives login screen display 221a. It is preferable that login identifier 232 differs from registration identifier 222, because in this embodiment, as stated above, registration identifier 222 uses on as-is basis what is sent to user 10 by mailer 160, and registration identifier 222 is exposed to a danger of being seen furtively by an imprudent person since it is sent to user 10 in an unencrypted way via e-mail. Since login identifier 223 is already imbedded in login screen 231a, user 10 is relieved from the burden of entering and administering this login identifier. Field 233 is a field for entering a login password (of eight characters, for example) that user 10 has chosen and registered in user management table 210 in advance. A login password can be the same as a registration password, or it can be a different password. Field 234 is a field that is clicked to reply a registration password to authenticator 100 via Web enabled communication after the user has inputted the registration password.

In reference to FIG. 3(b), login screen display 231b comprises fields for message 235 and ‘Return’ button 236. Message 235 indicates to user 10 that login password entered is wrong, and a retry is prompted. ‘Return’ button 236 is a button that makes it possible for user 10 to retry the password by switching login screen display 231b to 231a.

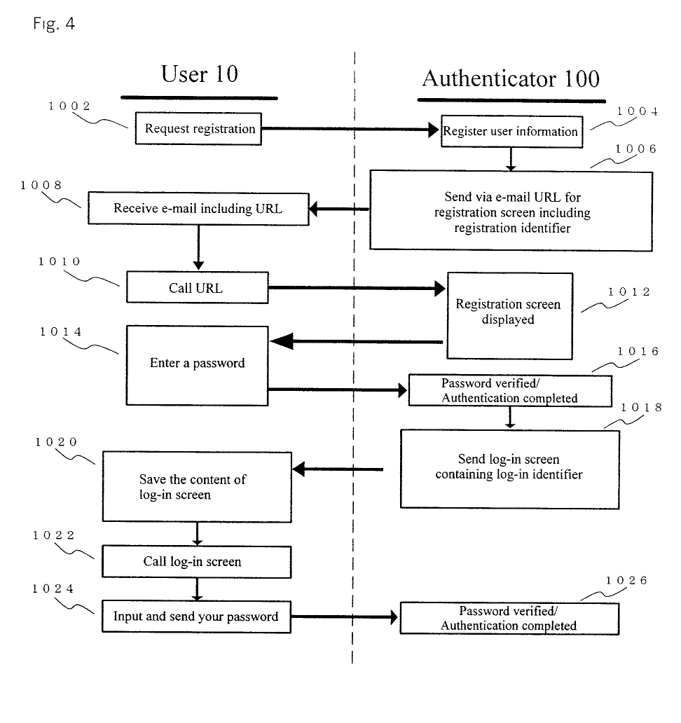

In reference to FIG. 4, a description will be made below of a series of actions taken when user 10 gets authenticated by authenticator 100 by taking advantage of authentication system 1. Here, FIG. 4 is a flowchart for explaining a series of actions followed when user 10 gets authenticated by authenticator 100 by using authentication system 1. Here, cellular phone 10A, shown in FIG. 1, is supposed to indicate the cellular phone of a legitimate user, and cellular phone 10B, the cellular phone of an illegitimate user.

At first, user 10A makes a user registration request to an administrator of authenticator 100 offline using a cellular phone, FAX, or mail (step 1002). If user 10 has a desktop PC besides a cellular phone, it is quite easy to make an input using a mouse or a keyboard, thus being able to directly make a user registration to authenticator 100 online. However, in the present case, a cellular phone, rather than a PC, is to be registered.

Authenticator 100 or its administrator that receives the request, makes an entry of user information requested by user 10 (i.e., user 10's name, address, sex, age, birthday, telephone number, e-mail address, type of his cellular phone, authentication information for his password (for registration and login) (which can be the password itself, but should include all information needed to authenticate this), tapes of services selected, necessary charge information (bank account, credit card, etc.), key for encryption, and other ID related information), and registers it in user management table 210 of storage 200 (step 1004). At the time of registration, CPU 110 encrypts user information via encryptor/decryptor 140, or merely stores the information in user management table 210 of storage 200 without encrypting it.

When authenticator 100 or its administrator completes the registration of the user information, CPU 110 sends URL of registration screen 221 to the e-mail address of cellular phone 10A via mailer 160 and communication port 120, as well as writing registration identifier 222 and effective period 225 into corresponding registration screen 221a (step 1006). Before sending URL of registration screen 221, CPU 110 refers to user management table 210 of storage 200 in advance, thus acquiring URL of accessible registration screen 221a into the type of cellular phone 10A, and randomly generating a registration identifier, by using random number generator 130, that identifies the cellular phone 10A, which is to be included in registration screen 221a. The timing with which CPU 110 gives e-mail can be at the time when registration of user information into authenticator 100 is completed or at the time user 10 makes a request.

Upon receipt of an e-mail that includes URL of registration screen 221a (step 1008), user 10A calls upon registration screen 221a (step1010). At this point of time, as the URL is contained in the e-mail, user 10A need not use the key pad of his cellular phone to input the URL purposely. Instead, user 10A can reverse the URL of the e-mail to push ‘Decision’ key, usually equipped, and click/double-click the URL, thereby calling the URL of registration screen 221a.

In response to this, CPU 110 displays the corresponding registration screen 221a (step 1012). CPU 110 determines the type of the cellular phone, calling for the URL, based on the number, contained in the URL, which is peculiar to a machine type. Registration identifier 222, which is peculiar to cellular phone 10A, is written in registration screen 221a in a modifiable way. CPU 110 prompts user 10 to enter the registration password via registration screen 221a. Generally speaking, the browser for a PC can use encryption for Web enabled communication and e-mail enabled communication, but in the case of a cellular phone, encryption can be applied for Web enabled communication, while on the other hand it cannot be applied for e-mail enabled communication. Therefore, according to the embodiment of the present invention, when a URL containing a number specific to the machine type of a cellular phone is given via e-mail, since it is exposed to a danger of being furtively listened to, resulting in the URL being leaked, the password should be confirmed, and it should be verified that the request is from legitimate user 10A.

Later on, user 10A puts the registration password from registration screen 221a into field 223 to reply to authenticator 100 (step 1011). Communication at this time is changed from e-mail enabled communication to Web enabled communication; and the registration password is encrypted for transmission; thus, there is no danger for the password to be stolen and leaked.

If a wrong registration password is entered, registration screen display 221b is sent to user 10A, who is prompted to retry the registration password. At this time, considering a case where cellular phone 10A was forgotten somewhere or stolen, and the registration password is used by illegitimate user 10B, it is possible to make the registration screen 221a unusable if illegitimate user 10B makes as many errors consecutively in retrying the password as the times set up when the registration password was settled, even if the registration screen 221a is still within the effective period. If the effective period defined in field 225 has expired, registration screen 221c will be sent to user 10A to indicate this. In this case, user 10 will make an online or offline contact with authenticator 100 or its administrator afresh, requesting that URL of new registration screen 221a be sent. When illegal person 10B takes possession of the URL and registration password, and inputs the registration password to field 223 of registration screen 221a, and if cellular phone 10B of the illegal person sends its phone type identifier automatically, registration screen 221d will be sent to user 10B, thereby warning him that a machine type used is wrong.

If user 10A encrypts and sends a correct registration password to authenticator 100 within the effective period, CPU 110 will decrypt the received registration password via encryptor/decryptor 140, and authenticate it by referencing the authentication information of the registration password stored in user management table 210 of storage 200. If the authentication is successful and CPU 110 authenticates user 10A, control of the registration by CPU 110 will terminate (step 1016).

Next, when control of the registration ends and legitimate user 10A is authenticated, CPU 110 will write login identifier 232 into login screen 231a, and send it to user 10A (step 1018). As stated above, some machine types of cellular phones may send a machine identifier automatically; so, CPU 110 can use it for login identifier 232. But even if it is not used, no problems will arise, and thus it does not follow that the present invention will be restricted by whether or not the cellular phone itself can issue an identifier. In this embodiment of the present invention, CPU 110 imbeds login identifier into login screen 231a in a way hidden from user 10A, and sends login screen 231a to user 10A after encrypting it at encryptor/decryptor 140. Since login screen 231a is sent in an encrypted state, there is no danger that login identifier 232, which is imbedded in login screen 231a in a hidden state, will be furtively seen and leaked.

Then, user 10A will use the screen memo function of cellular phone 10A to save login screen 231a (step 1020). Such an action corresponds to the screen saving for a PC. CPU 110, by the way, takes step 1018, because referencing user management table 210, it is aware that user 10A can perform step 1020.

When user 10A wants to access authenticator 100, user 10A will call the login screen saved on the cellular phone (step 1022), and enter and send login password 233 to authenticator 100. Since the identifier for user 10 is imbedded in the login screen in advance, user need not enter identification information afresh on login screen 231a, thus making the key operation simple. As already stated above, login password 233 can be the same as, or different from, the registration password. Since the sending of the login screen from user 10 to authenticator 100 is done over Web, the content of login screen 231a will be encrypted, and so, there is no danger that ID information or login password for user 10 will be stealthily seen and get leaked.

If a wrong login password 233 is entered, login screen 231b will be sent to user 10A, thus prompting a retry of login password 233 to be made.

If user 10A encrypts and sends a correct login password 233 to authenticator 100, CPU 110 will decrypt received login password 233 via encryptor/decryptor 140, and verifies it against authentication information of the login password stored in user management table 210 of storage 200. If the verification is successful, and CPU 110 authenticates user 10A, control of the login by CPU 110 will end (step 1026). After that, CPU 110 will make it possible for user 10A to access information provider 20. As a result, user 10A will access information in information provider 20 by way of simple key operation.

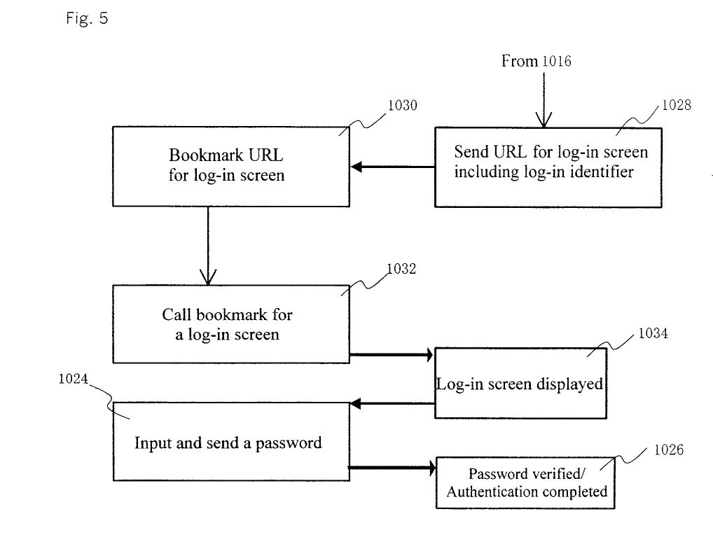

FIG. 5 is a variation example of FIG. 4. In FIG. 5, CPU is previously aware from user management table 210 that user 10A cannot perform step 1020, but can only bookmark URL of the login screen. Therefore, in place of step 1018, it will send URL of login screen 231a which contains login identifier 232 (step 1028). In response to this, user 10A will bookmark such URL (step 1030). When user 10A wants to make an access, he will call login screen 231a whose URL is bookmarked in his cellular phone (step 1032), make authenticator 110 display login screen 231a (step 1034), and then run into step 1024.

So far, a description of a preferable embodiment of the present invention has been given, but a variety of variations and changes of the present invention are feasible in the scope of its application.

Effects of the Invention

The authentication method and device used for the present invention will assure an easy, inexpensive, highly secure, and sure authentication operation for a user in general, particularly for such a user as uses a communication device whose key operation is complicated.

What is claimed is:

1. An authentication method comprising the steps of:
sending an address of a registration screen to a communication device of a user, the address including a registration identifier for identifying the user and/or the communication device;
authenticating the user based on the registration identifier and a first password that is entered in the registration screen and returned when the address is accessed;
sending a login screen to the user when the authenticating step succeeds, the login screen including a field into which a second password is entered, and a login identifier for identifying the user and/or the communication device; and
authenticating the user based on the login identifier included in the login screen, and the second password that are returned by the user.

2. An authentication method according to claim 1, wherein the registration identifier and the login identifier differ from each other.

3. An authentication method according to claim 1, wherein the first and second passwords are the same.

4. An authentication method according to claim 1, wherein the login identifier in the login screen is a device identifier that the communication device automatically sends for particularly identifying the communication device.

5. An authentication method according to claim 1, wherein the step of sending the login screen to the user enables the user to save contents of the login screen in the communication device.

6. An authentication method according to claim 1, wherein an address of the login screen includes the identifier; and
wherein the step of sending the login screen to the user enables the user to save the address of the login screen in the communication device.

7. An authentication method according to claim 1, wherein the authenticating step using the registration identifier and the first password disables the registration screen to be accessed when the authenticating step succeeds.

8. An authentication method according to claim 1, wherein the first password that has been entered in the registration screen and returned will not be accepted unless the password is returned within a predetermined time.

9. An authentication device comprising:
a storage part that stores user information, a registration identifier, a registration password verification information, login identifier, login password verification information while correlating them with one another;
a first control part that sends an address of a registration screen to a communication device of a user, the address including a registration identifier for identifying the user and/or the communication device;
a second control part that provides the communication device with the registration screen including a field into which a registration password is entered, and the registration identifier in response to a request for the registration screen from the communication device, and that authenticates the user with reference to the storage part when the user enters the login password in the registration screen and returns the same; and
a third control part that provides the communication device with the login screen including a field into which a login password is entered, and the login identifier when the authentication succeeds, and that authenticates the user with reference to the storage part when the user enters the login password in the login screen and returns the same.
